(19) United States
(12) Patent Application Publication
(10) Pub. No.: US 2025/0330469 A1
(43) Pub. Date: Oct. 23, 2025

(54) REMOTE LOGIN RESOURCE ACCESS CONTROL USING A CONTAINER

(71) Applicant: RED HAT, INC., Raleigh, NC (US)

(72) Inventors: Daniel Walsh, Augusta, GA (US); Lokesh Shyamsunder Mandvekar, Quebec City (CA); Petr Lautrbach, Brno (CZ)

(21) Appl. No.: 18/637,623

(22) Filed: Apr. 17, 2024

(51) Int. Cl. H04L 9/40

(52) U.S. Cl. CPC H04L 63/10

(57) ABSTRACT

A system can be used to control access to protected resources with respect to remote access of a computing environment. The system can execute a service file to generate a container in a host system based on user input received from a user device to initiate a login session. The service file can correspond to the user input. Subsequent to generating the container, the system can execute a user shell associated with the container to assign the user device to the container. The container can restrict the user device to access a set of predefined resources indicated in the service file. In response to detecting that the login session has ended, the system can remove the container associated with the user device from the host system.

### TECHNICAL FIELD

The present disclosure relates generally to computing environments. More specifically, but not by way of limitation, this disclosure relates to using a container to control access to computing resources of a remote login session.

### BACKGROUND

A container is a relatively isolated virtual environment created by leveraging the resource isolation features (e.g., cgroups and namespaces) of the Linux Kernel. Deploying software services inside containers can help isolate the software services from one another, which can improve speed and security and provide other benefits. Containers are deployed from image files using a container engine, such as Docker®. These image files are often referred to as container images. A container image can be conceptualized as a stacked arrangement of layers in which a base layer is positioned at the bottom and other layers are positioned above the base layer. The other layers may include a target software service and its dependencies, such as its libraries, binaries, and configuration files. The target software service may be configured to run (e.g., on a guest operating system) within the isolated context of the container.

### BRIEF DESCRIPTION OF THE DRAWINGS

FIG. 1 is a block diagram of an example of a computing environment for using at least one container to control access to computing resources of a remote login session according to some examples of the present disclosure.

FIG. 2 is a block diagram of an example of a computing environment for assigning a first user and a second user to separate containers to control access to computing resources of a remote login session according to some examples of the present disclosure.

FIG. 3 is a block diagram of an example of a computing environment for assigning a first user and a third user to the same container to control access to computing resources of a remote login session according to some examples of the present disclosure.

FIG. 4 is a block diagram of an example computing device for using at least one container to control access to computing resources of a remote login session according to some examples of the present disclosure.

FIG. 5 is a flowchart of a process for using at least one container to control access to computing resources of a remote login session according to some examples of the present disclosure.

### DETAILED DESCRIPTION

A user can access a computing environment, such as an operating system, through physical access or remote access. Physical access of the computing environment can involve the user inputting user credentials through an input device while being physically located at a location associated with the computing environment. Remote access of the computing environment can involve accessing computing resources provided by the computing environment over a network. Due to increasing availability to work from alternative locations and increasing use of cloud systems, users may tend to remotely access the computing environment through the network rather than physically accessing the computing environment. In some cases, the computing environment may include protected computing resources that certain users are authorized to access, whereas other users may be restricted from accessing the protected computing resources, such as due to a lack of authorization. Since users with different privileges or authorizations may remotely access the same computing environment, often at the same time, restricting unauthorized users from accessing the protected computing resources can be difficult.

Some examples of the present disclosure can overcome one or more of the issues mentioned above by using one or more containers to implement remote access control of the protected resources. For instance, the computing environment can include one or more virtual guests, such as the containers, running on one or more host machines. The containers can function as isolated virtual environments, enabling access control with respect to the protected resources. In particular, system resources assigned to one container may be private or inaccessible by other containers. Accordingly, the computing environment can include a respective container corresponding to each user such that each container is customized to only include system resources that a corresponding user is allowed to access. The containers can be relatively lightweight in terms of sharing hardware and an operating system kernel amongst each other, thereby preventing unauthorized access to the protected resources while consuming relatively less computing resources.

In some implementations, the computing environment can include a system manager to oversee a respective lifecycle of each container in the computing environment. In some cases, the system manager can function in conjunction with a container engine and a service tool to manage the containers used to provide remote access control in the computing environment. The container engine can provide container management with respect to generating and removing the containers in the computing environment. The service tool can be compatible with the container engine and the system manager to facilitate configuration of the containers in the computing environment through the system manager. For instance, a particular container may be generated based on executing a service file generated by an administrator using the service tool.

In one particular example, a system manager, such as systemd, can manage a respective lifecycle of one or more containers generated based on a respective authorization of a group of users. Based on a particular user of the group of users initiating a remote login session, the system manager can initiate a container including system resources that the particular user is authorized to access. Once the particular user terminates the remote login session, the system manager can remove the container from the computing environment. By removing the container after the particular user terminates the remote login session, the system manager can enable a redistribution of computing resources previously consumed by the container to other active containers in the computing environment.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

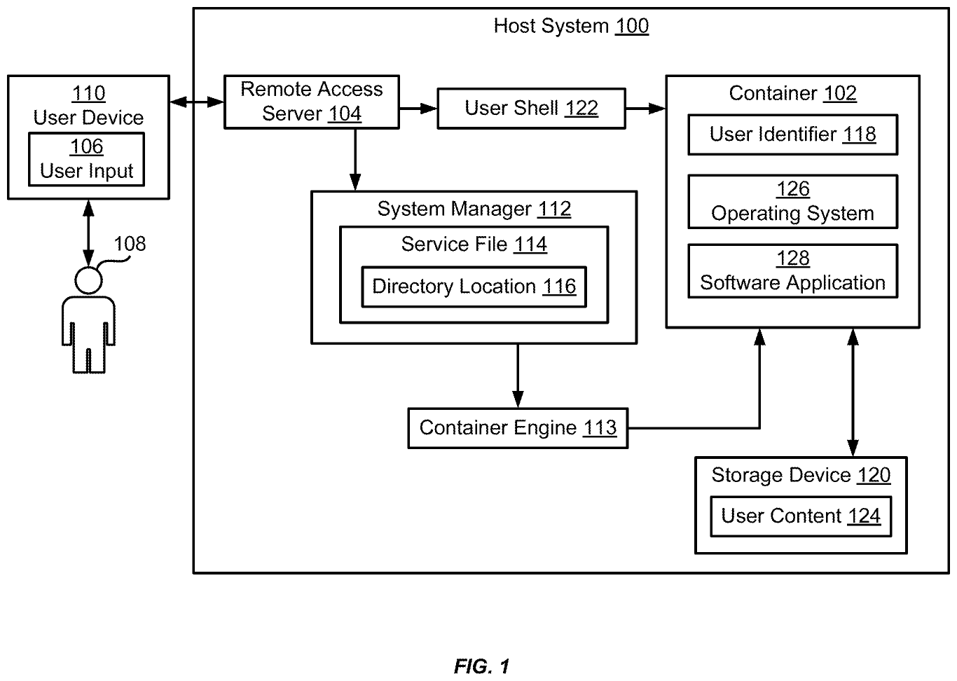

FIG. 1 is a block diagram of an example of a computing environment for using at least one container 102 to control access to computing resources of a remote login session according to some examples of the present disclosure. Components within the computing environment may be communicatively coupled via a network, such as a local area network (LAN), wide area network (WAN), the Internet, or any combination thereof. For example, the computing environment can be a host system 100 that can include two or more components communicatively coupled through the network. Examples of the host system 100 can include a desktop computer, laptop computer, server, mobile phone, or tablet.

As depicted in FIG. 1, the host system 100 can include a remote access server 104 that can receive user input 106 from a user 108, such as to initiate a remote login session. The remote login session can refer to a connection between a user device 110 associated with the user 108 and a faraway machine, such as a server. The remote access server 104 can perform user authentication based on the user input 106 received from the user 108. For example, the user 108 may provide login credentials, such as a username and password, via the user input 106 to the user device 110. In addition to user authentication, the remote access server 104 may handle encryption, terminal connections, file transfers, tunneling, or a combination thereof. In some cases, the remote access server 104 can be a program that is run as root (e.g., as a superuser or an administrator). As an example, the remote access server 104 can use a Secure Shell (SSH) protocol that can enable a secure transmission of commands over an unsecured network.

Based on the remote access server 104 successfully authenticating the user 108 using the user input 106, a system manager 112 of the host system 100 can generate the container 102 to which the user 108 can be assigned. As an example, the system manager 112 can be systemd or other suitable software that can manage user processes. In some cases, the system manager 112 can cooperate with a container engine 113 (e.g., Podman, Docker, etc.) to manage a lifecycle of the container 102, such as from generating the container 102 to removing the container 102 from the host system 100. For example, Podman can be a container engine 113 that is integrated with systemd to maintain the container 102 in the host system 100 until the container 102 is deactivated or otherwise removed. The container engine 113 can cause the container 102 to comply with security policies, such as Security-Enhanced Linux (SELinux), to ensure a separation of information based on confidentiality or integrity requirements.

In some examples, the system manager 112 can generate the container 102 based on the user input 106 received from the user device 110 to initiate the remote login session. For example, the system manager 112 may execute a service file 114 corresponding to the user input 106 to create and manage the container 102 as a service. The system manager 112 may locate the service file 114 based on a directory location 116 related to a user identifier 118 indicated in the user input 106 inputted by the user 108. As an example, the user identifier 118 may be a unique sequence of characters corresponding to the user 108. Using the unique sequence of characters of the user identifier 118, the system manager 112 can identify the directory location 116 where the service file 114 is accessible.

The service file 114 can define the computing resources accessible by the user 108 via the container 102. In some examples, the host system 100 can provide the computing resources available in the container 102 using at least one storage device 120, such as a volume. The storage device 120 can provide persistent data storage with respect to data of the user device 110. In other words, the data stored in the storage device can remain available after the container 102 is stopped or deactivated, such as due to the storage device being configured to store data in the host system 100. When generating the container 102, such as using the system manager 112, the host system 100 can map the storage device 120 to the container 102. As an example, mapping the storage device 120 to the container 102 can involve mounting the storage device 120 to the container 102. In particular, the storage device 120 can be mounted at a specific path within an image that includes instructions for creating the container 102.

Based on using the service file 114 to build the container 102, the host system 100 can prevent the user device 110 from accessing certain capabilities of the host system 100. In some cases, an administrator may generate the service file 114 based on authorization or permissions associated with the user 108. For example, if the host system 100 includes confidential information, the container 102 to which the user device 110 is assigned may only provide access to certain confidential information that the user 108 is allowed to interact with, such by viewing, downloading, etc. Examples of the confidential information can include secrets, personal identifiable information, medical records, etc. In some implementations, the service file 114 can be a Quadlet file, which can enable the container 102 to be run under the system manager 112 in a declarative way.

Once the container 102 is generated, the host system 100 can execute a user shell 122 associated with the container 102 to assign the user device 110 associated with the user 108 to the container 102. The user shell 122 can also be described as assigning the user 108 to the container 102. In some cases, the user shell 122 can be executed within the container 102. The user shell 122 can provide services associated with the container 102 to the user 108 using the user device 110, such as via a user interface. In other words, the user shell 122 can function as a connection between the user 108 or the user device 110 and the container 102. Examples of the user interface can include a command-line interface (CLI) or a graphical user interface (GUI). Examples of the services provided to the user 108 can include file management, process management with respect to running and terminating programs, etc.

Based on being assigned to the container 102, the user device 110 can be limited to the computing resources accessible via the container 102, thereby restricting the user device 110 to a set of predefined resources indicated in the service file 114. In some examples, the computing resources available to the user device 110 can include storage, random-access memory (RAM), central processing unit (CPU), network throughput, electrical power, input/output operations, etc. Due to isolation afforded by the container 102, the set of predefined resources available in the container 102 can be different from system resources of the host system 100 or other computing resources available in other containers of the host system 100. The restriction of the computing resources may affect access (e.g., write access, application access, network access, etc.) of the user device 110. In particular, the container 102 can be defined to prevent the user device 110 from performing read operations or write operations, accessing a particular network or communication protocol, etc. In some cases, if the user 108 is able to use the user device 110 to perform write operations and generate user content 124, the user content 124 can be stored in the storage device 120. Accordingly, the storage device 120 can provide persistent data storage with respect to the user content 124. Additionally or alternatively, the computing resources of the container 102 can relate to a particular computing environment of the container 102. For example, the system manager 112 may build the container 102 using the service file 114 to include an operating system 126 that is different from another operating system running on the host system 100. As another example, the container 102 may allow the user device 110 to access a software application 128 installed on the host system 100 while preventing the user device 110 from accessing additional software applications available in the host system 100.

Once the user 108 has accessed the computing resources of the container 102, the user 108 may terminate the remote login session. For example, the user 108 can interact with a user interface using the user device 110 to provide subsequent user input to log out from the container 102. Based on detecting that the remote login session has ended, the system manager 112 can remove the container 102, such as by deactivating the container 102. In some examples, the system manager 112 may deactivate the container 102 after a predefined time window has passed after the detection that the remote login session has ended. The storage device 120 associated with the container 102 can persist after the container 102 is removed such that the user 108 can access data stored in the storage device 120 at a later time, even after the container 102 is removed. For example, the user content 124 stored in the storage device 120 can include one or more files or other data that the user device 110 can access at a subsequent login session after the container 102 is deactivated.

While FIG. 1 depicts a specific arrangement of components, other examples can include more components, fewer components, different components, or a different arrangement of the components shown in FIG. 1. For instance, in other examples, more than one user may access the host system 100 such that a separate container corresponding to each user is generated in the host system 100. Additionally, any component or combination of components depicted in FIG. 1 can be used to implement the process(es) described herein.

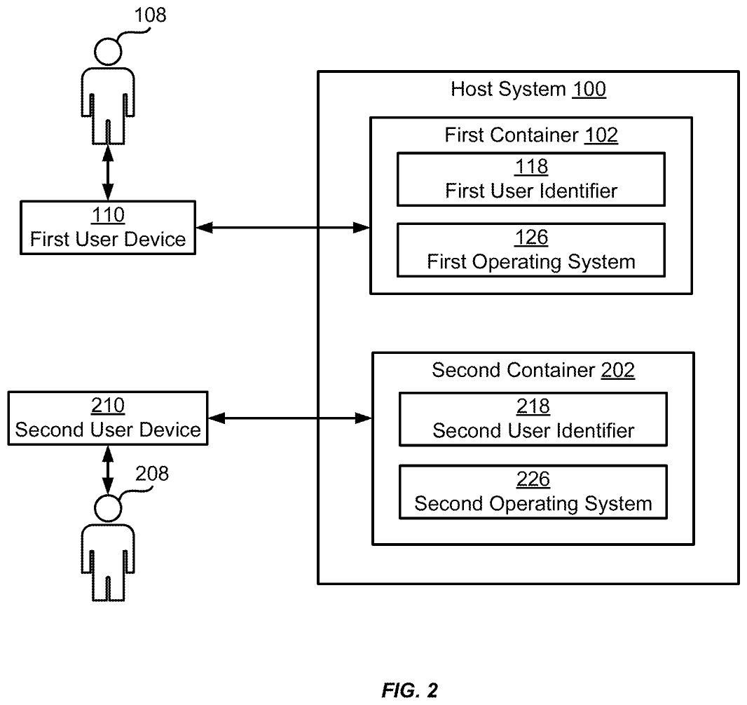

FIG. 2 is a block diagram of an example of a computing environment for assigning a first user 108 and a second user 208 to separate containers 102, 202 to control access to computing resources of a remote login session according to some examples of the present disclosure. Certain aspects of FIG. 2 are described below with reference to components of FIG. 1. In some examples, the host system 100 may include more than one container, such as the first container 102 and a second container 202, as depicted in FIG. 2.

The first container 102 can provide access to a different set of predefined resources than the second container 202 such that the host system 100 can provide different levels of access for different users. In some cases, a first user 108 and a second user 208 may both remotely access the host system while having different authorization or permissions. For example, the first user 108 may use a first user device 110 provide a first set of user credentials as user input to initiate a first login session. Similarly, the second user 208 can use a second user device 210 to provide a second set of user credentials to initiate a second login session. Each set of user credentials or other suitable user input provided by the first user 108 and the second user 208 may include a respective user identifier corresponding to each user. The host system 100 can identify the first user 108 and the second user 208 based on the respective user identifier, such as a first user identifier 118 corresponding to the first user 108 and a second user identifier 218 of the second user 208.

In some examples, the host system 100 may receive the first set of user credentials prior to the second set of user credentials. Accordingly, the host system 100 may first generate the first container 102 and assign the first user device 110 to the first container 102 prior to generating the second container 202. As an example, subsequent to the host system 100 assigning the first user device 110 to the first container 102, the second user device 210 may transmit additional user input, such as the second set of login credentials, to initiate the second login session. Based on the second user identifier 218 being different from the first user identifier 118, the host system 100 can generate the second container 202 to which the second user device 210 can be assigned. In some examples, the host system 100 may generate the second container 202 by executing a second service file that different from a first service file used to generate the first container 102. Once the second container 202 is created, the host system 100 can assign the second user device 210 to the second container 202, restricting the second user device 210 to a subset of computing resources provided via the second container 202.

As an example, the host system 100 may assign the first user device 110 to the first container 102 such that the first user 108 is allowed to access a compiler using the first user device 110. In contrast, the second container 202 may lack access to the compiler, thereby preventing the second user 208 from using the second user device 210 to compile code. An inability of the second user device 210 to compile code can prevent the second user 208 from executing malware or implementing other unauthorized modifications to the host system 100, such as to the second container 202. As another example, the first user 108 may be associated with higher risk than the second user 208, such as due to a physical location at which the first user 108 is positioned. Consequently, the second container 202 can allow the second user device 210 to upload files, whereas the first container 102 may lack a functionality of uploading files to minimize vulnerability to unauthorized modifications. At a later time, such as when the first user 108 has relocated to a different location that is relatively safer than an initial location of the first user 108, an administrator may update the first service file associated with the first container 102. Based on the updated service file, the host system 100, such as using the system manager 112 and a container engine 113, can update the first container 102 to enable the first user device 110 to have upload privileges.

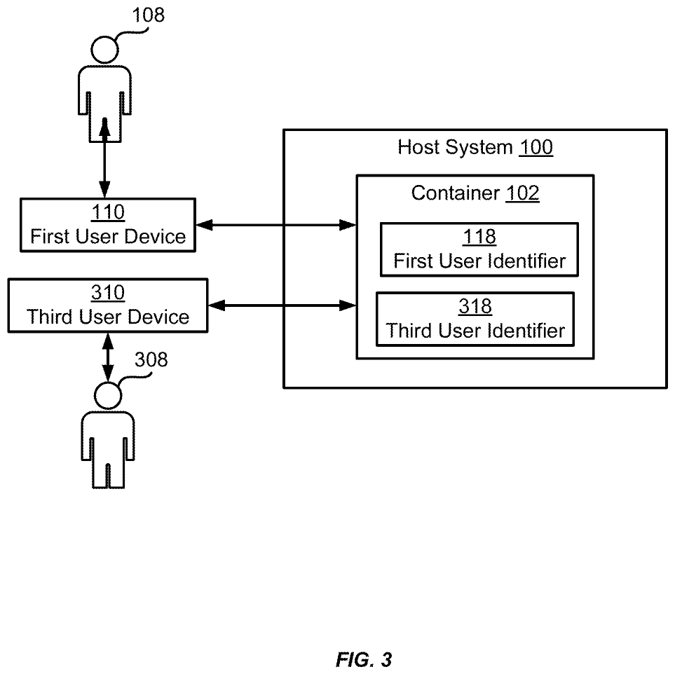

FIG. 3 is a block diagram of an example of a computing environment for assigning a first user 108 and a third user 308 to the same container 102 to control access to computing resources of a remote login session according to some examples of the present disclosure. Certain aspects of FIG. 2 are described below with reference to components of FIG. 1. In some examples, more than one user device, such as a first user device 110 and a third user device 310, may be assigned to the same container 102 after initiating a respective login session. The first user 108 can initiate a login session by providing login credentials via the first user device 110 while the third user 308 can initiate a different login session via the third user device 310.

In some implementations, the first user 108 and the third user 308 may be associated with a particular group that shares authorization, privileges, or permissions. For example, the particular group may correspond to a respective role of the first user 108 and the third user 308. In particular, the first user 108 and the third user 308 may both be developers that have read access and write access to generate and deploy code. Accordingly, in some examples, the first user 108 and the third user 308 can have the same group-level identifier while having different user identifiers. Once the first user 108 and the third user 308 initiate the respective login session, the host system 100 can assign the first user device 110 and the third user device 310 to the container 102 based on the group-level identifier. Accordingly, by assigning the third user device 310 to the container 102, the third user device 310 can be restricted to access a set of predefined resources available in the container 102. As described above with respect to FIG. 1, the set of predefined resources can include access-related authorization, such as write access or read access that can be provided as part of the set of predefined resources. Additionally or alternatively, the set of predefined resources can prevent the third user device 310 from accessing certain software applications or a particular operating system installed on the host system 100 or other containers in the host system 100.

In other implementations, the first user 108 and the third user 308 may correspond to the same entity using different user devices. For example, the entity may initiate a first login session using a mobile device and a second login session using a desktop by inputting the same login credentials to the mobile device and the desktop. Accordingly, the host system 100 can determine that the first user 108 and the third user 308 correspond to each other based on the login credentials used to initiate the login sessions. Based on the login credentials, the host system 100 can assign the first user device 110 and the third user device 310 to the same container 102 such that the entity can access a same set of predefined resources using the mobile device and the desktop.

In examples in which more than one user is assigned to the same container 102, after one user logs out, the host system 100 can determine whether any other user devices remain assigned to the container 102 prior to removing the container 102. For example, if the first user 108 logs out of its login session, the host system 100 can continue to maintain the container 102 based on determining that the third user device 310 remains assigned to the container 102. If the container 102 remains active after the first user device 110 ends its login session, the first user device 110 may be reassigned to the container 102 after initiating a subsequent login session.

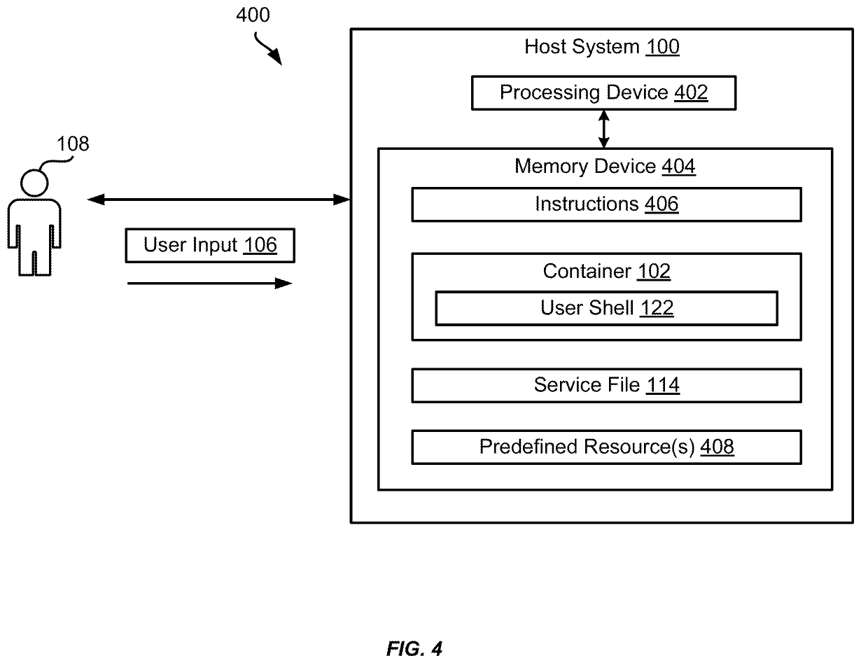

FIG. 4 is a block diagram of an example computing device for using at least one container 102 to control access to computing resources of a remote login session according to some examples of the present disclosure. The computing environment 400 can include a processing device 402 communicatively coupled to a memory device 404. Certain aspects of FIG. 4 are described below with reference to components of FIG. 1.

The processing device 402 can include one processing device or multiple processing devices. The processing device 402 can be referred to as a processor. Non-limiting examples of the processing device 402 include a Field-Programmable Gate Array (FPGA), an application-specific integrated circuit (ASIC), and a microprocessor. The processing device 402 can execute instructions 406 stored in the memory device 404 to perform operations. In some examples, the instructions 406 can include processor-specific instructions generated by a compiler or an interpreter from code written in any suitable computer-programming language, such as C, C++, C#, Java, Python, or any combination of these.

The memory device 404 can include one memory device or multiple memory devices. The memory device 404 can be non-volatile and may include any type of memory device that retains stored information when powered off. Non-limiting examples of the memory device 404 include electrically erasable and programmable read-only memory (EEPROM), flash memory, or any other type of non-volatile memory. At least some of the memory device 404 includes a non-transitory computer-readable medium from which the processing device 402 can read instructions 406. A computer-readable medium can include electronic, optical, magnetic, or other storage devices capable of providing the processing device 402 with the instructions 406 or other program code. Non-limiting examples of a computer-readable medium include magnetic disk(s), memory chip(s), ROM, random-access memory (RAM), an ASIC, a configured processor, and optical storage.

In some examples, the processing device 402 can execute the instructions 406 to use a container 102 to control which predefined resources 408 are accessible by a user 108. As an example, the container 102 may run an older version of an operating system than the operating system of a host system 100 in which the container 102 is deployed. As another example, the predefined resources 408 can include the operating system 126 and the software application 128 of FIG. 1. The processing device 402 can generate the container 102 based on user input 106 received from the user 108 to initiate a login session. The processing device 402 can generate the container 102 by executing a service file 114 located using the user input 106.

Subsequent to generating the container 102, the processing device 402 can execute a user shell 122 associated with the container 102 to assign the user device 110 to the container 102. By generating the container 102 using the service file 114, the processing device 402 can limit capabilities or functionalities provided by the container 102, thereby restricting the user 108 to access the predefined resources 408. After generating the container 102, the processing device 402 can continue to monitor the container 102 over a lifecycle of the container 102. The lifecycle of the container 102 may end due to the user device 110 terminating the login session based on input received from the user 108. Based on detecting that the user device 110 has terminated the login session, the processing device 402 can remove the container 102 associated with the user 108.

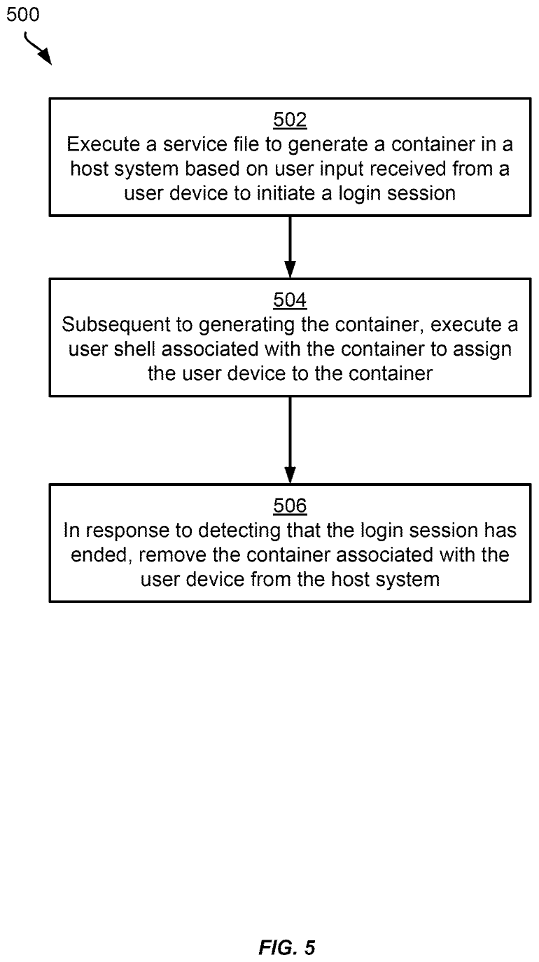

FIG. 5 is a flowchart of a process 500 for using at least one container 102 to control access to computing resources of a remote login session according to some examples of the present disclosure. In some examples, the processing device 402 can perform one or more of the steps shown in FIG. 5. In other examples, the processing device 402 can implement more steps, fewer steps, different steps, or a different order of the steps depicted in FIG. 5. The steps of FIG. 5 are described below with reference to components discussed above in FIGS. 1 and 4.

In block 502, the processing device 402 executes a service file XXX to generate a container 102 in a host system 100 based on user input 106 received from a user device 110 to initiate a login session. In some examples, the service file 114 can correspond to the user input 106 received from the user device 110, such as from a user 108. As an example, the processing device 402 can execute a Quadlet file as the service file 114 to generate a Podman container to which the user 108 can be assigned after the login session is initiated. The Quadlet file can be created to indicate one or more volumes to be leaked into the container 102, where the volumes provide computing resources that are accessible via the container 102.

In block 504, subsequent to generating the container 102, the processing device 402 executes a user shell 122 associated with the container 102 to assign the user device 110 to the container 102. The user shell 122 can provide a user interface for display at an output device, such as a display, of the user device 110 associated with the user 108. In some examples, the user shell 122 can be executed within the container 102. Assigning the user device 110 to the container 102 can enable the user 108 to access the computing resources available in the container 102 via the user device 110. In other words, the computing resources accessible by the user 108 can be limited to the computing resources provided in the container 102.

In block 506, in response to detecting that the login session has ended, the processing device 402 removes the container 102 associated with the user device 110 from the host system 100. The processing device 402 can monitor a lifecycle of the container 102 from initiating the container 102 at block 502 to terminating the container 102 at block 506. While monitoring the container 102, the processing device 402 can determine whether the user device 110 is communicatively coupled to the container 102. Based on a connection between the user device 110 and the container 102 ending, the processing device 402 can determine that the login session has ended. In some cases, the processing device 402 may stop the container 102 prior to deleting the container 102. A stopped container may be restarted one or more times before being removed by the processing device 402.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
executing a service file to generate a container in a host system based on user input received from a user device to initiate a login session, the service file corresponding to the user input;
subsequent to generating the container, executing a user shell associated with the container to assign the user device to the container, the container configured to restrict the user device to access a set of predefined resources indicated in the service file; and
in response to detecting that the login session has ended, removing the container associated with the user device from the host system.

2. The system of claim 1, wherein the set of predefined resources comprises write access, and wherein the operations further comprise:
mapping a storage device to the container to provide persistent data storage with respect to user content received from the user device;
prior to detecting that the login session has ended, receiving the user content generated based on the write access provided as part of the set of predefined resources; and
storing the user content in the storage device, wherein the storage device enables the user device to access the user content subsequent to removing the container.

3. The system of claim 1, wherein the set of predefined resources comprises a software application installed on the host system, and wherein the operations further comprise:
determining, based on the service file, that the user device is authorized to access the software application; and
providing the software application in the container to allow the user device to access the software application.

4. The system of claim 1, wherein generating the container based on the user input comprises:
receiving the user input to initiate the login session, wherein the user input comprises a user identifier corresponding to a user of the user device;
subsequent to receiving the user input, identifying a directory location at which the service file is accessible, wherein the user identifier is configured to indicate the directory location; and
based on the directory location, executing the service file to generate the container associated with the user identifier.

5. The system of claim 1, wherein the user device is a first user device that has initiated a first login session and has been assigned to a first container based on a first user identifier, and wherein the operations further comprise:
subsequent to assigning the first user device to the first container, receiving additional user input from a second user device to initiate a second login session, wherein the additional user input comprises a second user identifier;
based on the first user identifier being different than the second user identifier, generating a second container to provide access to a different set of predefined resources than the first container; and
subsequent to generating the second container, assigning the second user device to the second container.

6. The system of claim 1, wherein the user device is a first user device that has initiated a first login session and has been assigned to the container based on a first user identifier, and wherein the operations further comprise:
subsequent to assigning the first user device to the container, receiving additional user input to initiate a third login session, wherein the additional user input comprises a third user identifier; and
based on the first user identifier being associated with the third user identifier, assigning a third user device to the container such that the third user device is restricted to access the set of predefined resources.

7. The system of claim 1, wherein the set of predefined resources comprises an operating system, and wherein the operations further comprise:
based on the set of predefined resources indicated in the service file, providing the operating system via the container such that the operating system is accessible by the user device.

8. A method comprising:
executing a service file to generate a container in a host system based on user input received from a user device to initiate a login session, the service file corresponding to the user input;
subsequent to generating the container, executing a user shell associated with the container to assign the user device to the container, the container restricting the user device to access a set of predefined resources indicated in the service file; and
in response to detecting that the login session has ended, removing the container associated with the user device from the host system.

9. The method of claim 8, wherein the set of predefined resources comprises write access, and wherein the method further comprises:
mapping a storage device to the container to provide persistent data storage with respect to user content received from the user device;
prior to detecting that the login session has ended, receiving the user content generated based on the write access provided as part of the set of predefined resources; and
storing the user content in the storage device, wherein the storage device enables the user device to access the user content subsequent to removing the container.

10. The method of claim 8, wherein the set of predefined resources comprises a software application installed on the host system, and wherein the method further comprises:
determining, based on the service file, that the user device is authorized to access the software application; and
providing the software application in the container to allow the user device to access the software application.

11. The method of claim 8, wherein generating the container based on the user input comprises:
receiving the user input to initiate the login session, wherein the user input comprises a user identifier corresponding to a user of the user device;
subsequent to receiving the user input, identifying a directory location at which the service file is accessible, wherein the user identifier indicates the directory location; and
based on the directory location, executing the service file to generate the container associated with the user identifier.

12. The method of claim 8, wherein the user device is a first user device that has initiated a first login session and has been assigned to a first container based on a first user identifier, and wherein the method further comprises:
subsequent to assigning the first user device to the first container, receiving additional user input from a second user device to initiate a second login session, wherein the additional user input comprises a second user identifier;
based on the first user identifier being different than the second user identifier, generating a second container to provide access to a different set of predefined resources than the first container; and
subsequent to generating the second container, assigning the second user device to the second container.

13. The method of claim 8, wherein the user device is a first user device that has initiated a first login session and has been assigned to the container based on a first user identifier, and wherein the method further comprises:
subsequent to assigning the first user device to the container, receiving additional user input to initiate a third login session, wherein the additional user input comprises a third user identifier; and
based on the first user identifier being associated with the third user identifier, assigning a third user device to the container such that the third user device is restricted to access the set of predefined resources.

14. The method of claim 8, wherein the set of predefined resources comprises an operating system, and wherein the method further comprises:
based on the set of predefined resources indicated in the service file, providing the operating system via the container such that the operating system is accessible by the user device.

15. A non-transitory computer-readable medium comprising program code executable by a processing device for causing the processing device to perform operations comprising:
executing a service file to generate a container in a host system based on user input received from a user device to initiate a login session, the service file corresponding to the user input;
subsequent to generating the container, executing a user shell associated with the container to assign the user device to the container, the container configured to restrict the user device to access a set of predefined resources indicated in the service file; and
in response to detecting that the login session has ended, removing the container associated with the user device from the host system.

16. The non-transitory computer-readable medium of claim 15, wherein the set of predefined resources comprises write access, and wherein the operations further comprise:
mapping a storage device to the container to provide persistent data storage with respect to user content received from the user device;
prior to detecting that the login session has ended, receiving the user content generated based on the write access provided as part of the set of predefined resources; and
storing the user content in the storage device, wherein the storage device enables the user device to access the user content subsequent to removing the container.

17. The non-transitory computer-readable medium of claim 15, wherein the set of predefined resources comprises a software application installed on the host system, and wherein the operations further comprise:
determining, based on the service file, that the user device is authorized to access the software application; and
providing the software application in the container to allow the user device to access the software application.

18. The non-transitory computer-readable medium of claim 15, wherein generating the container based on the user input comprises:
receiving the user input to initiate the login session, wherein the user input comprises a user identifier corresponding to a user of the user device;
subsequent to receiving the user input, identifying a directory location at which the service file is accessible, wherein the user identifier is configured to indicate the directory location; and
based on the directory location, executing the service file to generate the container associated with the user identifier.

19. The non-transitory computer-readable medium of claim 15, wherein the user device is a first user device that has initiated a first login session and has been assigned to a first container based on a first user identifier, and wherein the operations further comprise:
subsequent to assigning the first user device to the first container, receiving additional user input from a second user device to initiate a second login session, wherein the additional user input comprises a second user identifier;
based on the first user identifier being different than the second user identifier, generating a second container to provide access to a different set of predefined resources than the first container; and
subsequent to generating the second container, assigning the second user device to the second container.

20. The non-transitory computer-readable medium of claim 15, wherein the user device is a first user device that has initiated a first login session and has been assigned to the container based on a first user identifier, and wherein the operations further comprise:
subsequent to assigning the first user device to the container, receiving additional user input to initiate a third login session, wherein the additional user input comprises a third user identifier; and
based on the first user identifier being associated with the third user identifier, assigning a third user device to the container such that the third user device is restricted to access the set of predefined resources.
